(19) United States
(12) Patent Application Publication
(10) Pub. No.: US 2026/0126843 A1
(43) Pub. Date: May 7, 2026

(54) POWER-DOWN HOLDING CIRCUIT FOR POWER SUPPLY COMPONENT, AND CONTROL METHOD AND CONTROL APPARATUS THEREFOR,AND SERVER POVER SUPPLY SYSTEM

(71) Applicant: SUZHOU METABRAIN INTELLIGENT TECHNOLOGY CO., LTD., Suzhou, Jiangsu (CN)

(72) Inventors: Deyang HUA, Suzhou, Jiangsu (CN); Lingyan WANG, Suzhou, Jiangsu (CN); Jianyu LI, Suzhou, Jiangsu (CN); Dongyu ZHANG, Suzhou, Jiangsu (CN); An WU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/117,341

(22) PCT Filed: Dec. 26, 2023
(86) PCT No.: PCT/CN2023/141953

§ 371 Date: Mar. 31, 2025

(30) Foreign Application Priority Data
May 29, 2023 (CN) 202310617098.4

(51) Int. Cl. G06F 1/30; G06F 1/3206; G06F 1/3296

(52) U.S. Cl. CPC G06F 1/30; G06F 1/3206; G06F 1/3296

(57) ABSTRACT

A power-down holding circuit for power supply component, and a control method and control apparatus therefor, and a server power supply system are provided. Multiple power supply components are provided, and the power supply component includes an input circuit and an output circuit. The power-down holding circuit includes: an input energy storage component electrically connected to output terminals of the input circuits of the multiple power supply components; an output energy storage component, including multiple output energy storage modules, where first terminals of the output energy storage modules are configured to be electrically connected to the input terminals of the output circuits in a one-to-one correspondence, and second terminals of the output energy storage modules are grounded; and an intermediate energy storage component, including an intermediate energy storage module and a first switch module.

### CROSS-REFERENCE TO RELATED APPLICATION

This application claims priority to Chinese Patent Application No. 202310617098.4, filed with the China National Intellectual Property Administration on May 29, 2023 and entitled “POWER-DOWN HOLDING CIRCUIT FOR POWER SUPPLY COMPONENT, AND CONTROL METHOD AND CONTROL APPARATUS THEREFOR”, which is incorporated herein by reference in its entirety.

### TECHNICAL FIELD

Embodiments of this application relate to the field of server power supply, particularly to a power-down holding circuit for power supply component, a control method and control apparatus therefor, and a server power supply system.

### BACKGROUND

With the rapid growth of high-performance computing applications such as artificial intelligence, machine learning, and big data mining, centralized computing and storage in data centers are booming. To meet these ever-increasing demands, a large number of large-scale data centers for data computation, processing, and storage have been built, and data centers are becoming critical infrastructure supporting the normal operation of modern society. Data security and device reliability are increasingly emphasized, leading to the rapid development and construction of high-level large-scale data centers with increasingly complex redundancy. To achieve high data security, the power supply systems need to have varying levels of power reliability, where higher requirements lead to increasing complexity of the power supply component systems. There are different redundancy structures from low to high reliability, with power supply components adopting 1+1 redundancy, N+1 redundancy, N+N redundancy, or even 2×(N+1) redundancy.

Although multiple redundancies achieve high reliability, they also limit the power density and energy efficiency of the power supply systems. they cause significant waste in power supply system space and power consumption.

### SUMMARY

Embodiments of this application provide a power-down holding circuit for power supply component, a control method and control apparatus therefor, and a server power supply system.

According to an embodiment of this application, a power-down holding circuit for power supply component is provided, where multiple power supply components are provided, the power supply component includes an input circuit and an output circuit, an output terminal of the input circuit is electrically connected to an input terminal of the output circuit, and the power-down holding circuit includes: an input energy storage component, where the input energy storage component is configured to be electrically connected to all the output terminals of the input circuits of the multiple power supply components; an output energy storage component, including multiple output energy storage modules, where first terminals of the output energy storage modules are configured to be electrically connected to the input terminals of the output circuits in a one-to-one correspondence, and second terminals of the output energy storage modules are grounded; and an intermediate energy storage component, including an intermediate energy storage module and a first switch module, where a first terminal of the intermediate energy storage module is configured to be electrically connected to all the output terminals of the multiple input circuits, a second terminal of the intermediate energy storage module is electrically connected to a first terminal of the first switch module and the first terminal of each output energy storage module, and a second terminal of the first switch module is grounded.

In some embodiments, the output energy storage component further includes at least one of the following: multiple current limiting components, where the current limiting components are connected in series, in a one-to-one correspondence, to connection circuits between the output energy storage modules and the output circuits; and multiple voltage clamping components, where the multiple voltage clamping components are connected in parallel, each corresponding to two terminals of the output energy storage module.

In some embodiments, the current limiting component includes a resistor, the voltage clamping component includes a first diode, an anode of the first diode is electrically connected to the second terminal of the output energy storage module, and a cathode of the first diode is electrically connected to the first terminal of the output energy storage module.

In some embodiments, the output energy storage component further includes multiple third switch modules, where the second terminal of the intermediate energy storage module is electrically connected to the first terminal of the output energy storage module via the third switch module, and the third switch modules are in a one-to-one correspondence to the output energy storage modules.

In some embodiments, the third switch module includes a second diode, an anode of the second diode is electrically connected to the second terminal of the intermediate energy storage module, and a cathode of the second diode is electrically connected to the first terminal of the output energy storage module.

In some embodiments, the multiple output energy storage modules are respectively a first output energy storage module, a second output energy storage module, . . . , an i-th output energy storage module, . . . , and an n-th output energy storage module, and the output energy storage component further includes n fourth switch modules, where the second terminal of the intermediate energy storage module is electrically connected to the first terminal of the first output energy storage module via a first fourth switch module, a first terminal of an i-th fourth switch module is electrically connected to a first terminal of an (i−1)-th output energy storage module, a second terminal of the i-th fourth switch module is electrically connected to the first terminal of the i-th output energy storage module, and 1<i≤n.

In some embodiments, the fourth switch module includes at least one of the following: a third diode and a bidirectionally conductive switching tube.

In some embodiments, the power-down holding circuit further includes: multiple transducer switch modules, where the transducer switch modules are connected in series in a one-to-one correspondence between the input circuits and the corresponding output circuits.

In some embodiments, the input energy storage component includes multiple input energy storage modules, where first terminals of the input energy storage modules are electrically connected to the output terminals of the input circuits in a one-to-one correspondence, and second terminals of the multiple input energy storage modules are grounded.

In some embodiments, the input energy storage module, the output energy storage module, and the intermediate energy storage module each include at least one of the following: a capacitor and an inductor.

In some embodiments, the input energy storage component further includes: multiple second switch modules, where the first terminal of the intermediate energy storage module is configured to be electrically connected to all the input terminals of the multiple input circuits via the multiple second switch modules, and the second switch modules are in a one-to-one correspondence to the input terminals of the input circuits; and a shared energy storage module, where a first terminal of the shared energy storage module is electrically connected to the first terminal of the intermediate energy storage module, and a second terminal of the shared energy storage module is electrically connected to the second terminal of the first switch module.

In some embodiments, the first switch module and the second switch module each include one of the following: a transistor, a MOS transistor, and a thyristor, and the shared energy storage module includes at least one of the following: a capacitor and an inductor.

According to another embodiment of this application, a control method for the power-down holding circuit is provided, including: a first control step: a power supply component is controlled to power on in a case that the power supply component operates normally, causing an output terminal of an input circuit to output a preset voltage and charge an input energy storage component; a second control step: a first switch module is controlled to close in a case that the power supply component abnormally powers down, to charge an intermediate energy storage module; a third control step: the first switch module is controlled to open in a case that the power supply component abnormally powers down and a charging duration for the intermediate energy storage module reaches a preset duration, causing the intermediate energy storage module to discharge, so as to charge at least part of output energy storage module; and a cycling step: the second control step and the third control step are cyclically executed a predetermined number of times until a voltage of the at least part of the output energy storage modules reaches a first preset voltage.

In some embodiments, the first control step includes that the power supply component is controlled to power on and each second switch module is controlled to close, causing the output terminal of the input circuit to output the preset voltage, so as to charge each output energy storage module and the shared energy storage module.

In some embodiments, the method further includes that the cycling step is executed in a case that the voltage of the at least part of the output energy storage module is less than a second preset voltage, until the voltage of the at least part of the output energy storage module reaches the first preset voltage, the first preset voltage being greater than the second preset voltage.

In some embodiment, the method further includes that the first switch module is controlled to open in a case that part of the input circuit fails; and a transducer switch module corresponding to the failed input circuit is at least controlled to close, causing a corresponding output energy storage module of the closed transducer switch module to discharge.

In some embodiments, the multiple output energy storage modules are respectively a first output energy storage module, a second output energy storage module, . . . , an i-th output energy storage module, . . . , and an n-th output energy storage module; and the output energy storage component further includes n fourth switch modules, where the second terminal of the intermediate energy storage module is electrically connected to the first terminal of the first output energy storage module via a first fourth switch module, a first terminal of the i-th fourth switch module is electrically connected to a first terminal of an (i−1)-th output energy storage module, a second terminal of the i-th fourth switch module is electrically connected to the first terminal of the i-th output energy storage module, and 1<i≤n; where that the transducer switch module corresponding to the failed input circuit is at least controlled to close includes that the transducer switch module corresponding to the failed input circuit is controlled to close, the corresponding output energy storage module of the closed transducer switch module being a target energy storage module; and at least one target switch module is controlled to close, the target switch module being a fourth switch module electrically connected to a first terminal of the target energy storage module, causing at least two of the output energy storage modules to discharge in parallel.

In some embodiments, after the cycling step, the method further includes that the first switch module is controlled to open.

According to still another embodiment of this application, a control apparatus for the power-down holding circuit is provided, including a first control component, configured to execute a first control step: a power supply component is controlled to power on in a case that the power supply component operates normally, causing an output terminal of an input circuit to output a preset voltage and charge an input energy storage component; a second control component, configured to execute a second control step: a first switch module is controlled to close in a case that the power supply component abnormally powers down, to charge an intermediate energy storage module; a third control component, configured to execute a third control step: the first switch module is controlled to open in a case that the power supply component abnormally powers down and a charging duration for the intermediate energy storage module reaches a preset duration, causing the intermediate energy storage module to discharge, so as to charge at least part of output energy storage module; and a cycling component, configured to execute a cycling step: the second control step and the third control step are cyclically executed a predetermined number of times until a voltage of the at least part of the output energy storage modules reaches a first preset voltage.

According to yet another embodiment of this application, a server power supply system is also provided, including: multiple power supply components, where the power supply component includes an input circuit and an output circuit, and an output terminal of the input circuit is electrically connected to an input terminal of the output circuit; the power-down holding circuit described above; and a controller, including a memory, a processor, and a computer program stored on the memory and executable by the processor, where the processor executes the steps of the method described above when executing the computer program.

### BRIEF DESCRIPTION OF THE DRAWINGS

FIG. 1 is a schematic structural diagram of a server power supply system according to an embodiment of this application.

FIG. 2 is a schematic structural diagram of a power supply system in the related art.

FIG. 3 is a schematic structural diagram of an power supply system according to an embodiment of this application.

FIG. 4 is a schematic diagram of a power-down holding circuit according to an embodiment of this application.

FIG. 5 is a schematic diagram of another power-down holding circuit according to an embodiment of this application.

FIG. 6 is a schematic diagram of still another power-down holding circuit according to an embodiment of this application.

FIG. 7 is a block diagram of a controller for implementing a control method for the power-down holding circuit according to an embodiment of this application.

FIG. 8 is a flowchart of the control method for the power-down holding circuit according to an embodiment of this application.

FIG. 9 is a block diagram of a control apparatus for the power-down holding circuit according to an embodiment of this application.

The above figures include the following reference numerals:

100. power-down holding circuit; 10. input energy storage component; 11. input energy storage module; 12. second switch module; 13. shared energy storage module; 20. output energy storage component; 21. output energy storage module; 22. current limiting component; 23. voltage clamping component; 24. third switch module; 25. fourth switch module; 30. intermediate energy storage component; 31. intermediate energy storage module; 32. first switch module; 40. power supply component; 41. input circuit; 42. output circuit; 50. transducer switch module; 102. processor; 104. memory; 106. transmission equipment; and 108. input/output device.

### DETAILED DESCRIPTION OF THE EMBODIMENTS

The embodiments of this application will be described in detail below with reference to the accompanying drawings.

It should be noted that the terms “first,” “second,” and the like in the description, claims, and drawings of this application are used to distinguish similar objects and are not necessarily used to describe a specific order or sequence.

According to an aspect of this application, a power-down holding circuit for power supply component is provided. FIG. 1 is a schematic structural diagram of a power-down holding circuit according to an embodiment of this application. As shown in FIG. 1, multiple power supply components are provided, each power supply component includes an input circuit 41 and an output circuit 42, an output terminal of the input circuit 41 is electrically connected to an input terminal of the output circuit 42, and the power-down holding circuit includes:
an input energy storage component 10, where the input energy storage component 10 is configured to be electrically connected to all output terminals of input circuits 41 of multiple power supply components;
an output energy storage component 20, including multiple output energy storage modules 21, where first terminals of the output energy storage modules 21 are configured to be electrically connected to the input terminals of the output circuits 42 in a one-to-one correspondence, and second terminals 21 of the output energy storage modules are grounded; and
an intermediate energy storage component 30, including an intermediate energy storage module 31 and a first switch module 32, where a first terminal of the intermediate energy storage module 31 is configured to be electrically connected to all the output terminals of the multiple input circuits 41, a second terminal of the intermediate energy storage module 31 is electrically connected to a first terminal of the first switch module 32 and the first terminal of each output energy storage module 21, and a second terminal of the first switch module 32 is grounded.

Through the above embodiment, the output terminal of the input circuit and the input terminal of the output circuit of each power supply component are electrically connected. In the power-down holding circuit, the first terminal of the intermediate energy storage module is electrically connected to the output terminals of the multiple input circuits, and the second terminal of the intermediate energy storage module is electrically connected to both the first terminal of the first switch module and the first terminals of the output energy storage modules. The second terminal of the first switch module and the second terminals of the output energy storage modules are grounded. The input energy storage component is electrically connected to the output terminals of the input circuits of multiple power supply components, and the first terminals of the output energy storage modules are electrically connected to the corresponding output circuits of the power supply components. It can be seen that the power-down holding circuit of this application is bypassed between the input circuits and output circuits of multiple power supply components, functioning as an independent part to perform power-down holding operations. As compared with the related art where the power-down holding circuit is connected in series between the input circuit and output circuit of each power supply component, the solution of this application of bypassing the power-down holding circuit between the input circuits and output circuits might reduce the efficiency impact of the power-down holding circuit on the main power loop of the power supply component. Additionally, because the power-down holding circuit is not connected in series between the input and output circuits of the power supply component, the power requirements of the power-down holding circuit are lower. Furthermore, in this application, one power-down holding circuit corresponds to multiple power supply components, so the power-down holding circuit occupies less space, which is conducive to the integration and miniaturization design of servers.

In one embodiment, the power-down holding function of the power-down holding circuit is implemented as follows: In the power-down holding circuit, the first terminal of the intermediate energy storage module is electrically connected to the output terminals of the multiple input circuits, and the second terminal of the intermediate energy storage module is electrically connected to the first terminal of the first switch module and the first terminals of the output energy storage modules. The second terminal of the first switch module and the second terminals of the output energy storage modules are grounded. Closing the first switch module allows the intermediate energy storage module to be charged using the voltage input from the input circuit, such that the intermediate energy storage module stores energy. Opening the first switch module allows the intermediate energy storage module to discharge, so as to charge the output energy storage modules. In this way, in the case of input circuit failure, the charged output energy storage modules can discharge to maintain the working state of the output circuit, achieving the power-down holding function. Additionally, the input energy storage component is connected to the output terminal of each input circuit. During the charging and discharging actions of the intermediate energy storage module, the input energy storage component can might prevent excessive voltage fluctuations at the output terminals of the input circuits, thereby avoiding impacts on the input circuits.

In the related art, inside a PSU (Power Supply Component) of a server, there is a power-down holding circuit, the circuit is connected in series within a main power circuit, and large energy storage capacitors are used to maintain functionality in case of input port power-down failure, to meet the requirements of system equipment for power-down holding time, ensuring data security and reliability in fault conditions. In a multiple power supply component redundancy system, taking N+N redundancy as an example, there are 2N power supply components, with N backup components and N main components. In this case, 2N power-down holding circuits are connected in series within a main power circuit, occupying 2N times the space, where N main components work, meaning N power-down holding circuits work, which adds N single-stage losses; and N idle components lead to N additional single-stage static losses. Obviously, while the existing power supply components can achieve high redundancy and high reliability, they cause significant waste in power supply system space and power consumption.

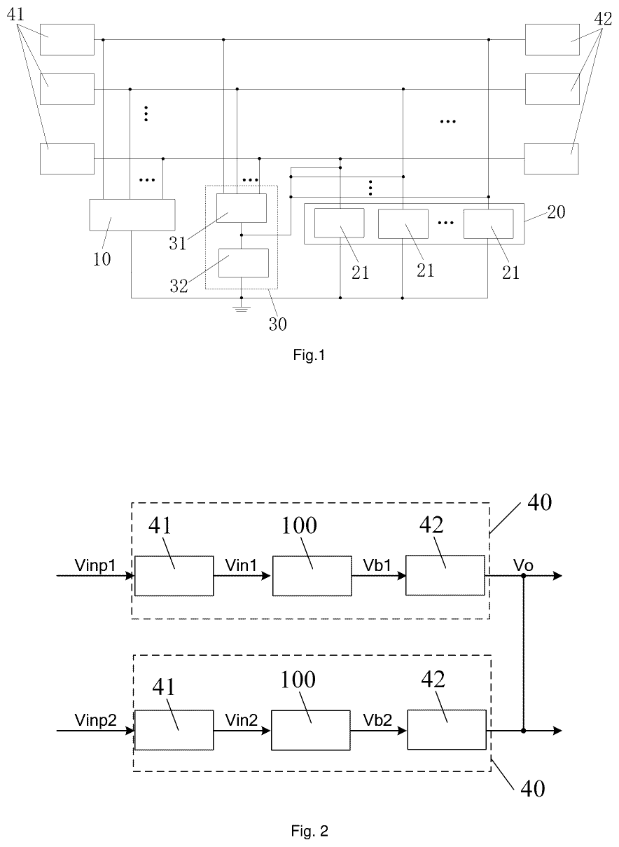

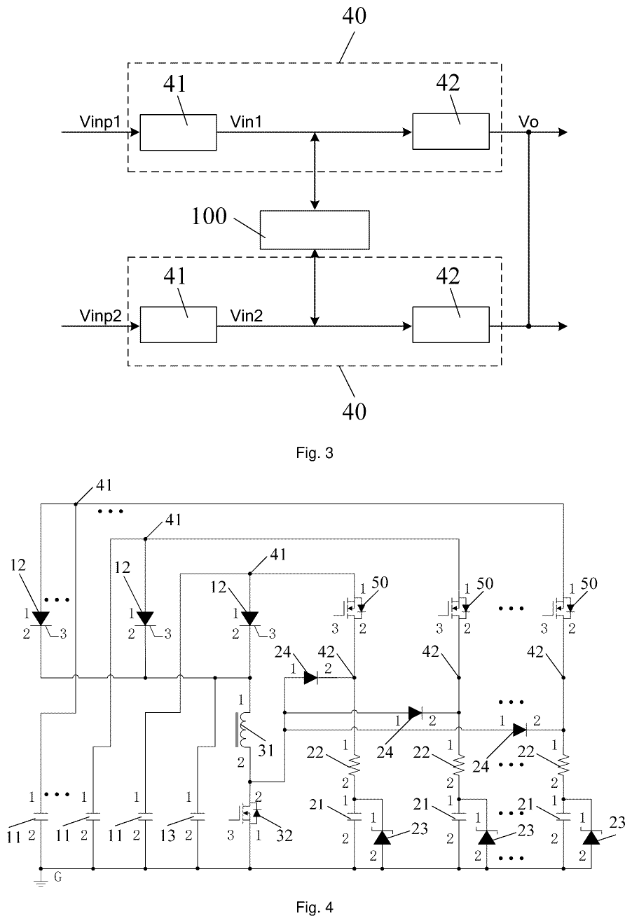

For example, the inputs of two power supply components are separately from dual buses Vinp1 and Vinp2 and the outputs are connected to achieve 1+1 backup redundancy. As shown in FIG. 2, the power-down holding circuit 100 in the related art is connected in series between the input circuit 41 and the output circuit 42, as part of the main loop of the power supply component 40. The efficiency and reliability of the power-down holding circuit 100 have a significant impact on the power supply component 40. For example, if the efficiency of the input circuit 41 is 99%, the efficiency of the power-down holding circuit 100 is 98%, and the efficiency of the output circuit 42 is 98%, the overall efficiency is 99%×98%×98%=95%. The power-down holding circuit 100 has a two-percentage-point impact on the overall efficiency of the power supply component 40, which does not meet the high-efficiency green energy-saving development trend. As shown in FIG. 3, in this application, the power-down holding circuit 100 is bypassed between the input circuits 41 and output circuits 42, having a minimal impact on the efficiency of the main power loop of the power supply component 40. For example, if the efficiency of the input circuit 41 is 99% and the efficiency of the output circuit 42 is 98%, the overall efficiency of the power supply component 40 is 99%×98%=97%. As compared with the related art, the main power efficiency of the power supply component in this application is higher, meeting the high-efficiency green energy-saving development trend.

According to another aspect, the power-down holding circuit of this application, as a bypass part of the main power of the power supply components, has its power and volume only related to the functions it realizes, and does not need to adapt to the power level requirements and volume requirements of the components of the power supply components. Therefore, the power devices used in the power-down holding circuit of this application, such as switch tubes and inductors, have relatively small power levels and volumes, thereby improving the space utilization of the entire power supply system. As compared with related art, in this application, all power supply components share one power-down holding circuit, reducing the volume of the energy storage module used to achieve the same function, improving space utilization, and meeting the design requirements of high power density. Moreover, more power supply components indicate more backup redundancy for the power supply components and greater value of this application than the related art.

In some optional embodiments of this application, as shown in FIGS. 4 to 6, the output energy storage component further includes at least one of the following:
multiple current limiting components 22, where the current limiting components 22 are connected in series, in a one-to-one correspondence, to connection circuits between the output energy storage modules 21 and the output circuits 42; and
multiple voltage clamping components 23, where the multiple voltage clamping components 23 are connected in parallel, each corresponding to two terminals of the output energy storage module 21.

In the above embodiments, during the charging and discharging process, the current limiting component can suppress the surge current flowing through the output energy storage module, preventing the surge current from damaging the output energy storage module during the charging and discharging process. The voltage clamping component can limit the voltage of the output energy storage module to a specified potential to provide voltage stabilization protection for the output energy storage module.

In one embodiment, the output energy storage component further includes at least one of the following: multiple current limiting components and multiple voltage clamping components, including the following three cases: First, the output energy storage component further includes multiple current limiting components, which can provide current protection for the output energy storage module. Second, the output energy storage component further includes multiple voltage clamping components, which can provide voltage protection for the output energy storage module. Third, the output energy storage component further includes multiple current limiting components and multiple voltage clamping components, through a simple and efficient transient protection design, achieving dual protection of voltage and current for the output energy storage module.

The current limiting components are connected in series, in a one-to-one correspondence, to the connection circuits between the output energy storage modules and the output circuits. In one embodiment, as shown in FIG. 4, the first terminal of the current limiting component is electrically connected to the input terminal of the output circuit, and the second terminal of the current limiting component is electrically connected to the first terminal of the output energy storage module. Certainly, in addition to the connection method shown in FIG. 4, the current limiting components may alternatively be connected in series to the connection circuits between the output energy storage modules and the output circuits in this way, where the first terminal of the current limiting component is electrically connected to the second terminal of the output energy storage module, and the second terminal of the current limiting component is grounded. Both the above connection methods of the current limiting components can enable the current limiting components to achieve the current limiting function during the charging and discharging process. In addition to the above two connection methods, the current limiting components may alternatively be connected as follows: the first terminal of the current limiting component is electrically connected to the output terminal of the output circuit, and the second terminal of the current limiting component is electrically connected to the output terminal of the input circuit. In this case, when the output energy storage module discharges, the current limiting component can still provide the current limiting function, but during the charging process of the intermediate energy storage module to the output energy storage module, the current limiting component no longer functions. Those skilled in the art can flexibly arrange the connection position of the current limiting components based on actual needs, as long as the current limiting components are connected in series to the connection circuits between the output energy storage modules and the output circuits, which is not limited in this application.

In practical applications, those skilled in the art may choose any suitable component as the current limiting component, such as a resistor or capacitor. Similarly, those skilled in the art may also choose any suitable clamping component as the above voltage clamping component. According to some example embodiments of this application, as shown in FIG. 4, the current limiting component 22 includes a resistor, and the bidirectional current limiting effect can be achieved through the resistor.

As shown in FIG. 4, the voltage clamping component 23 includes a first diode, an anode of the first diode is electrically connected to the second terminal of the output energy storage module 21, and a cathode of the first diode is electrically connected to the first terminal of the output energy storage module 21. In one embodiment, the first diode may be a zener diode or a transient voltage suppression diode.

In one embodiment, the current limiting component may be a power resistor or composed of multiple power resistors connected in series and parallel. The voltage clamping component may be a zener diode or a transient voltage suppression diode.

In some embodiments, as shown in FIG. 4, the output energy storage component further includes multiple third switch modules 24, where the second terminal of the intermediate energy storage module 31 is electrically connected to the first terminal of the output energy storage module 21 via the third switch module 24, and the third switch modules 24 are in a one-to-one correspondence to the output energy storage modules 21. In other words, the first terminal of each third switch module 24 is electrically connected to the intermediate energy storage module 31, and the second terminal of the third switch module 24 is electrically connected to the first terminal of the output energy storage module 21 in a one-to-one correspondence. The third switch module is arranged between the intermediate energy storage module and the output energy storage module. Controlling the switch of the third switch module determines whether the intermediate energy storage module discharges to the output energy storage module. In addition, controlling the switch of the third switch module can also prevent current from flowing to the intermediate energy storage module when the output energy storage module discharges.

In one embodiment, in the case that the output energy storage component includes the current limiting component, FIG. 4 shows a connection method in which the second terminal of the third switch module 24 is electrically connected to the first terminal of the current limiting component 22 through the input terminal of the output circuit 42, and the second terminal of the current limiting component 22 is electrically connected to the first terminal of the output energy storage module 21. In other words, the third switch module is electrically connected to the output energy storage module 21 via the input terminal of the output circuit 42 and the current limiting component 22 in sequence.

In some embodiments, as shown in FIG. 4, the third switch module 24 includes a second diode, an anode of the second diode is electrically connected to the second terminal of the intermediate energy storage module 31, and a cathode of the second diode is electrically connected to the first terminal of the output energy storage module 21. With the arrangement of the second diode that conducts unidirectionally from the intermediate energy storage module to the output energy storage module, the intermediate energy storage module can charge the output energy storage module without the need to control its switch. Furthermore, due to the unidirectional conduction characteristic of the second diode, the output energy storage module can supply power to the output circuit during discharging, and the current does not flow back to the intermediate energy storage module.

Certainly, the third switch module is not limited to including the diode mentioned above; the third switch module may include other switch tubes, such as transistors or MOS transistors. In an optional embodiment, the third switch module may be the second diode. The second diode may be a Schottky diode, which has low power consumption, high efficiency, and a voltage stabilization function, optionally ensuring the safe operation of the circuit.

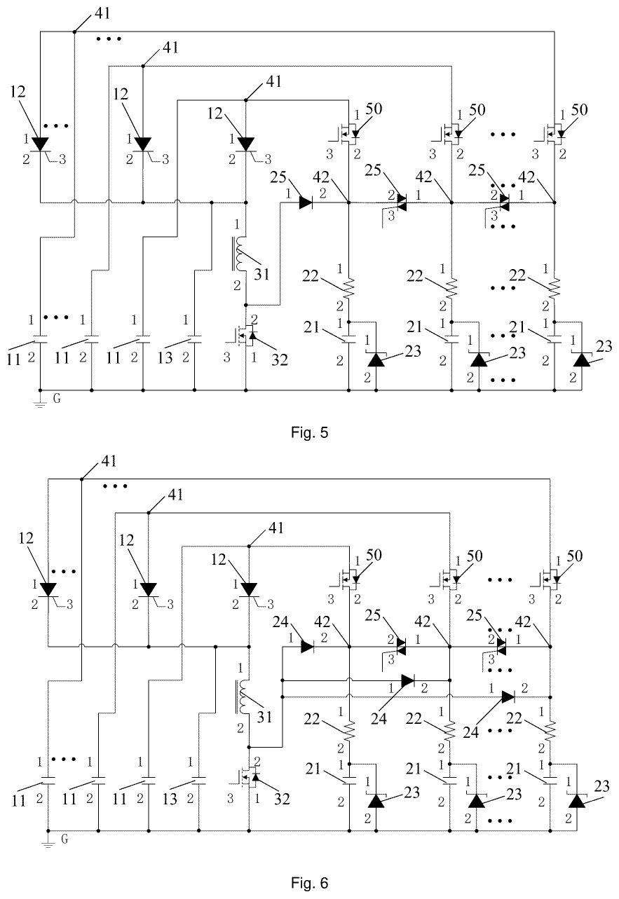

In addition to the arrangement of the third switch modules, in some embodiments, as shown in FIG. 5, the multiple output energy storage modules 21 are respectively a first output energy storage module 21, a second output energy storage module 21, . . . , an i-th output energy storage module 21, . . . , and an n-th output energy storage module 21, and the output energy storage component further includes n fourth switch modules 25, where the second terminal of the intermediate energy storage module 31 is electrically connected to the first terminal of the first output energy storage module 21 via a first fourth switch module 25, a first terminal of an i-th fourth switch module 25 is electrically connected to a first terminal of an (i−1)-th output energy storage module 21, a second terminal of the i-th fourth switch module 25 is electrically connected to the first terminal of the i-th output energy storage module 21, and 1<i≤n. In other words, except for the first fourth switch module, which is connected in series between the intermediate energy storage module and the first output energy storage module, the other fourth switch modules are connected in parallel between adjacent output energy storage modules in a one-to-one correspondence.

In the above embodiments, controlling the switch of the first fourth switch module determines whether the intermediate energy storage module discharges to the output energy storage module. In addition, controlling the switch of the above fourth switch module can also prevent current from flowing to the intermediate energy storage module when the output energy storage module discharges. Controlling the other fourth switch modules can achieve parallel connection of any output energy storage modules. In the case of multiple input circuit failures, as the switches of the other fourth switch modules are connected, the number of output energy storage modules to be discharged can be selected, achieving parallel discharge of the corresponding number of output energy storage modules, and balancing the energy of the output energy storage modules, thereby more reasonably distributing energy to maintain the power-down holding time of each input terminal of the output circuit.

In one embodiment, the fourth switch module includes at least one of the following: a third diode and a bidirectionally conductive switching tube. In an optional embodiment, as shown in FIG. 5, the first fourth switch module includes the third diode, the anode of the third diode is electrically connected to the second terminal of the intermediate energy storage module, the cathode of the third diode is electrically connected to the first terminal of the first output energy storage module, and the other fourth switch modules, except for the first fourth switch module, include the bidirectionally conductive switch tube. Based on the arrangement of the third diode that conducts unidirectionally from the intermediate energy storage module to the output energy storage module, the intermediate energy storage module can charge the output energy storage module without the need to control its switch. Furthermore, due to the unidirectional conduction characteristic of the third diode, the output energy storage module can supply power to the output circuit during discharging, and the current does not flow back to the intermediate energy storage module. Additionally, the arrangement of the bidirectionally conductive switch tube can achieve parallel discharge of at least two output energy storage modules, thereby balancing the energy between the output energy storage modules, ensuring that the power-down holding time meets the power-down operation requirements of the output circuit.

In one embodiment, the first fourth switch module may be the third diode, the anode of the third diode is electrically connected to the second terminal of the intermediate energy storage module, the cathode of the third diode is electrically connected to the first terminal of the first output energy storage module, and the other fourth switch modules, except for the first fourth switch module, may be the bidirectionally conductive switch tube. The bidirectionally conductive switch tube may be a bidirectional thyristor with bidirectional control conduction capability.

In practical applications, the power-down holding circuit of this application may include only the third switch module as shown in FIG. 4, only the fourth switch module as shown in FIG. 5, or both the third switch module 24 and other fourth switch modules 25 except the first fourth switch module as shown in FIG. 6. In one embodiment, as shown in FIG. 6, the output energy storage component further includes multiple third switch modules 24, where the second terminal of the intermediate energy storage module 31 is electrically connected to the first terminal of the output energy storage module 21 via the third switch module 24, and the third switch modules 24 are in a one-to-one correspondence to the output energy storage modules 21, where in other words, the first terminal of each third switch module 24 is electrically connected to the intermediate energy storage module 31, and the second terminal of the third switch module is electrically connected to the first terminal of the output energy storage module 21 in a one-to-one correspondence; and n−1 fourth switch modules 25, where the first terminal of the i-th fourth switch module 25 is electrically connected to the first terminal of the (i−1)-th output energy storage module 21, and the second terminal of the i-th fourth switch module 25 is electrically connected to the first terminal of the i-th output energy storage module 21, and 1<i≤n.

To ensure that the voltage of the output terminal of the input circuit is relatively stable, in an optional embodiment as shown in FIGS. 4 to 6, the input energy storage component includes multiple input energy storage modules 11, where first terminals of the input energy storage modules 11 are electrically connected to the output terminals of the input circuits 41 in a one-to-one correspondence, and second terminals of the multiple input energy storage modules 11 are grounded.

In one embodiment, the number of the input energy storage modules may be the same as or different from the number of the output energy storage modules. In this application, the number of the input energy storage modules is set to be the same as the number of the output energy storage modules.

In practical applications, the input energy storage module, the output energy storage module, and the intermediate energy storage module may include any feasible energy storage components in the related art. In one embodiment, the input energy storage module, the output energy storage module, and the intermediate energy storage module each include at least one of the following: a capacitor and an inductor.

In this embodiment, the input energy storage module includes a first capacitor, the output energy storage module includes a second capacitor, and the intermediate energy storage module includes an inductor. Certainly, the input energy storage module is not limited to including the first capacitor; it may further include capacitors and inductors, or multiple capacitors, or multiple inductors. Similarly, the output energy storage module and the intermediate energy storage module may further include capacitors and inductors, or multiple capacitors, or multiple inductors.

In one embodiment, as shown in FIGS. 4 to 6, the input energy storage module is the first capacitor, the output energy storage module is the second capacitor, and the intermediate energy storage module is an inductor.

In some embodiments, as shown in FIGS. 4 to 6, the power-down holding circuit further includes multiple transducer switch modules 50, where the transducer switch modules 50 are connected in series in a one-to-one correspondence between the input circuits 41 and the corresponding output circuits 42. In other words, the first terminal of the transducer switch module is electrically connected to the output terminal of the input circuit, the transducer switch module is electrically connected to the input energy storage component via the output terminal of the input circuit, and the second terminal of the transducer switch module is electrically connected to both the input terminal of the output circuit and the first terminal of the output energy storage module. Through the transducer switch module, functional isolation between the power supply components is effectively achieved.

After the output energy storage modules are charged, if some or all of the input circuits fail and power down during operation, the transducer switch module corresponding to the failed input circuit is closed, such that the electrical energy of the corresponding output energy storage module is quickly transferred to the input energy storage component via the transducer switch module, thereby realizing energy replenishment to the input energy storage component corresponding to the fault channel.

As shown in FIGS. 4 to 6, the first terminal of the transducer switch module 50 is electrically connected to the first terminal of the input energy storage module 11 via the output terminal of the input circuit 41 in a one-to-one correspondence. In a case that the output energy storage component includes a current limiting component 22, the second terminal of the transducer switch module 50 is electrically connected to the first terminal of the current limiting component 22 via the input terminal of the output circuit 42, and the second terminal of the current limiting component 22 is electrically connected to the first terminal of the output energy storage module 21. After each output energy storage module 21 is fully charged, if any or all of the output terminals of multiple input circuits 41 fail and power down during the operation of the power supply components, the first switch module is controlled to disconnect (or the control circuit of the first switch module is closed and the first switch module is disconnected), and the transducer switch module 50 corresponding to the fault is controlled to close. The energy of the corresponding output energy storage module 21 is quickly transferred to the corresponding input energy storage module 11 via the corresponding current limiting component 22 and the corresponding transducer switch module 50, realizing energy sharing and replenishment, and giving the power consumption end and control system sufficient time to handle important business.

In practical applications, those skilled in the art can choose a suitable switch device as the transducer switch module. In an optional embodiment, the transducer switch module includes a three-terminal transistor, such as a MOS transistor, a transistor, or a thyristor. In another optional embodiment, the transducer switch module is a MOS transistor, such as an NMOS transistor. As shown in FIGS. 4 to 6, the source of the NMOS transistor is electrically connected to the output terminal of the input circuit, the drain of the NMOS transistor is electrically connected to the input terminal of the output circuit, and the gate of the NMOS transistor is electrically connected to the controller. The controller controls the switching state of the NMOS transistor, and the body diode of the NMOS transistor points from the output terminal of the input circuit to the input terminal of the output circuit.

It should be noted that without considering isolation between the input circuits, the transducer switch module may be omitted, and the output terminals of the input circuits may be electrically connected together (specifically, the second switch module 12 on the connection branch between each input circuit 41 and the intermediate energy storage module 31 in FIG. 4 is removed, such that the output terminals of the input circuits 41 are electrically connected together at the first terminal of the intermediate energy storage module 31), merging into a common output port. Additionally, without considering isolation between the output circuits, the input terminals of the output circuits may be electrically connected together (specifically, the input terminals of the output circuits 42 in FIG. 4 are electrically connected in sequence), merging into a common input port. It can be seen that the power-down holding circuit of this application may be in the form of multiple input ports and multiple output ports as shown in FIGS. 4 to 6, or simplified to the form of a common input port and multiple output ports, or simplified to the form of multiple input ports and a common output port, or simplified to the form of a common input port and a common output port. All these conform to the main idea of this application, which is energy sharing between the power supply component and the power-down holding circuit, effectively reducing the volume of the entire power supply system and improving reliability in fault conditions.

In some embodiments, as shown in FIGS. 4 to 6, the input energy storage component further includes:
multiple second switch modules 12, where the first terminal of the intermediate energy storage module 31 is configured to be electrically connected to all the input terminals of the multiple input circuits 41 via the multiple second switch modules 12, and the second switch modules 12 are in a one-to-one correspondence to the input terminals of the input circuits 41, meaning that the first terminal of the second switch module 12 is electrically connected to the input terminal of the input circuit 41 in a one-to-one correspondence, and the second terminal of the second switch module 12 is electrically connected to the first terminal of the intermediate energy storage module 31; and
a shared energy storage module 13, where a first terminal of the shared energy storage module 13 is electrically connected to the first terminal of the intermediate energy storage module 31, meaning that the first terminal of the shared energy storage module 13 is electrically connected to both the intermediate energy storage module 31 and the second terminal of each second switch module 12, and the second terminal of the shared energy storage module 13 is electrically connected to the second terminal of the first switch module 32, that is, the second terminal of the shared energy storage module 13 is grounded.

In the above embodiment, isolation of the output terminals of different input circuits can be achieved through the second switch module, that is, isolation of each power supply component can be achieved, effectively blocking the faulty power supply component from the normal power supply component, thereby ensuring high reliability of the power supply system. Closing the second switch module allows the output terminal of the input circuit to output voltage, so as to charge the shared energy storage module via the closed second switch module. Additionally, the shared energy storage module can balance the energy of each input energy storage module.

In some optional applications, the first switch module and the second switch module each include one of the following: a transistor, a MOS transistor, and a thyristor, and the shared energy storage module includes at least one of the following: a capacitor and an inductor.

Certainly, the first switch module and the second switch module are not limited to the above transistors, MOS transistors, or thyristors. When designing circuits, those skilled in the art may alternatively choose any suitable switch transistor from related art as the first switch module and the second switch module. Similarly, the shared energy storage module is not limited to the above capacitor and inductor, and may alternatively be another energy storage component.

In order to make the power-down holding circuit have high control precision and fast response speed, in this application, the first switch module is a high-frequency switch. For example, it may be a high-frequency transistor, a MOS transistor, a thyristor, or another high-frequency switch tube.

For example, the shared energy storage module includes a capacitor. The first switch module includes a high-frequency MOS transistor, and the second switch module includes a unidirectional thyristor or a bidirectional thyristor. In another optional embodiment, as shown in FIGS. 4 to 6, the shared energy storage module is a third capacitor, the first switch module is a high-frequency MOS transistor, the source of the MOS transistor is grounded, the drain of the MOS transistor is electrically connected to the first terminal of the intermediate energy storage module, and the gate of the MOS transistor is electrically connected to the controller. The second switch module is a bidirectional thyristor, the anode of the bidirectional thyristor is electrically connected to the output terminal of the input circuit, the cathode of the bidirectional thyristor is electrically connected to the first terminal of the intermediate energy storage module, and the control terminal of the bidirectional thyristor is electrically connected to the controller.

The above capacitors in this application include, but are not limited to, electrolytic capacitors, ceramic capacitors, and other large-capacity capacitors with energy storage functions.

In this application, the power supply components share a power-down holding circuit, effectively reducing the volume proportion of the independent energy storage circuits of the power supply components under multiple redundancy backups, particularly reducing the volume of the energy storage modules in the circuit structure. That is, the volume of the capacitors used in the power-down holding circuit is much smaller than the volume of the corresponding energy storage modules when each power supply component is individually equipped with a power-down holding circuit. The power-down holding circuit of this application adopts an integrated power section design, meaning that the fault energy compensation of all power supply components comes from one power converter, and each power supply component is connected to the energy-sharing compensation circuit via a high-speed switch. Using the power-down holding circuit of this application not only ensures that in the event of a power supply component failure, the energy supply of the power-down holding circuit can provide the electrical system with sufficient time to handle business processes, thus ensuring better and more reasonable reliability. This also saves design space of the power supply system, increases power density, and reduces the main power stages of the power supply component, thereby improving the efficiency of the power supply component, which is especially beneficial in multi-redundant backup power supply systems, where the benefits of this application become more apparent.

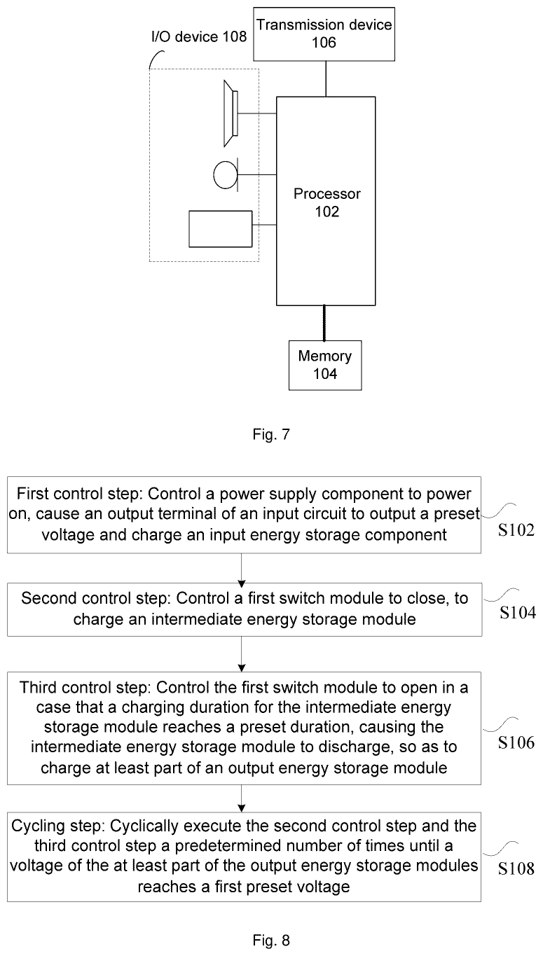

This application also provides a control method for the power-down holding circuit. The method embodiments provided in this application can be executed on mobile terminals, computer terminals, or similar computing devices. Taking operation on a mobile terminal as an example, FIG. 7 is a hardware block diagram of a mobile terminal for the control method for the power-down holding circuit according to an embodiment of this application. As shown in FIG. 7, the mobile terminal may include one or more (only one is shown in FIG. 7) processors 102 (the processor 102 may include, but is not limited to, a microcontroller component MCU or a programmable logic device FPGA) and a memory 104 configured to store data. The mobile terminal may also include transmission equipment 106 configured for communication functions, and input/output devices 108. Those skilled in the art can understand that the structure shown in FIG. 7 is only illustrative and does not limit the structure of the above mobile terminal. For example, the mobile terminal may include more or fewer components than those shown in FIG. 7, or have a different configuration from that shown in FIG. 7.

The memory 104 may be configured to store computer programs, such as software programs and modules of application software, for example, the computer program corresponding to the control method for the power-down holding circuit in the embodiments of this application. The processor 102 executes various functional applications and data processing by running the computer program stored in the memory 104, thereby implementing the above method. The memory 104 may include high-speed random access memory and may also include non-volatile memory, such as one or more magnetic storage devices, flash memory, or other non-volatile solid-state memory. In some instances, the memory 104 may include memory remotely located relative to the processor 102, and these remote memories may be connected to the mobile terminal via a network. Examples of the network include, but are not limited to, the Internet, intranets, local area networks, mobile communication networks, and combinations thereof.

The transmission equipment 106 is configured to receive or send data via a network. Optional examples of the network may include wireless networks provided by the mobile terminal's communication provider. In one instance, the transmission equipment 106 includes a network adapter (Network Interface Controller, abbreviated as NIC), which may be connected to other network devices via a base station to communicate with the Internet. In one instance, the transmission equipment 106 may be a radio frequency (Radio Frequency, abbreviated as RF) module, which is configured to communicate with the Internet wirelessly.

This embodiment provides the control method for the power-down holding circuit running on a controller. FIG. 8 is a flowchart of the control method for the power-down holding circuit according to an embodiment of this application. As shown in FIG. 8, the process includes the following steps:
Step S102, a first control step: The power supply component is controlled to power on in a case that the power supply component operates normally, causing the output terminal of the input circuit to output a preset voltage and charge the input energy storage component.
Step S104, a second control step: The first switch module is controlled to close in a case that the power supply component abnormally powers down, to charge the intermediate energy storage module.
Step S106, a third control step: The first switch module is controlled to open in a case that the power supply component abnormally powers down and a charging duration for the intermediate energy storage module reaches a preset duration, causing the intermediate energy storage module to discharge, so as to charge at least part of the output energy storage module.
Step S108, a cycling step: The second control step and the third control step are cyclically executed a predetermined number of times until a voltage of the at least part of the output energy storage modules reaches a first preset voltage.

Through the above steps, firstly, the power supply component is controlled to power on, such that the input circuit outputs a preset voltage through the output terminal to charge the input energy storage component, and then the first switch module is controlled to close, to charge the intermediate energy storage module. Next, the first switch module is controlled to open, stopping charging the intermediate energy storage module, thus allowing the intermediate energy storage module to discharge to supply energy to at least part of the output energy storage module. Finally, the first switch module is cyclically closed and opened, to repeat the process of charging the intermediate energy storage module and discharging the intermediate energy storage module to charge the output energy storage module, such that the stored voltage of the output energy storage module reaches the first preset voltage, achieving the power-up energy storage of the power-down holding circuit. The above process achieves the on-demand replenishment of the output energy storage module through the switch control of the first switch module. Thus, in a case of a fault in one or more of the input circuits, the output energy storage module after energy storage can output energy to maintain the function of the power supply component in a fault state. This allows sufficient time for the electrical system to handle emergency operations in the case of a power supply system failure, ensuring the safe operation of the electrical system.

The execution subject of the above steps may be the MCU or microcontroller of the server, but is not limited thereto.

In some embodiments, as shown in FIGS. 4 to 6, the input energy storage component includes multiple input energy storage modules 11, first terminals of the input energy storage modules 11 are electrically connected to the output terminals of the input circuits 41 in a one-to-one correspondence, and second terminals of the multiple input energy storage modules 11 are grounded. The input energy storage component further includes: multiple second switch modules 12, where the first terminal of the intermediate energy storage module 31 is configured to be electrically connected to all the input terminals of the multiple input circuits 41 via the multiple second switch modules 12, and the second switch modules 12 are in a one-to-one correspondence to the input terminals of the input circuits 41, meaning that the first terminal of the second switch module 12 is electrically connected to the input terminal of the input circuit 41 in a one-to-one correspondence, and the second terminal of the second switch module 12 is electrically connected to the first terminal of the intermediate energy storage module 31; and shared energy storage module 13, where a first terminal of the shared energy storage module 13 is electrically connected to the first terminal of the intermediate energy storage module 31, meaning that the first terminal of the shared energy storage module 13 is electrically connected to both the intermediate energy storage module 31 and the second terminal of each second switch module 12. The second terminal of the shared energy storage module 13 is electrically connected to the second terminal of the first switch module 32, meaning that the second terminal of the shared energy storage module 13 is grounded. The first control step includes that the power supply component is controlled to power on and each second switch module is controlled to close, causing the output terminal of the input circuit to output the preset voltage, so as to charge each output energy storage module and the shared energy storage module. The power supply component is controlled to power on, such that the output terminal of the input circuit inputs the preset voltage, directly charging each input energy storage module, and the second switch module is controlled to close, to charge the shared energy storage module.

In order to ensure that the power-down holding circuit can provide sufficient energy supply during a power-down, according to some example embodiments of this application, the method further includes that the cycling step is executed in a case that the voltage of the at least part of the output energy storage module is less than a second preset voltage, until the voltage of the at least part of the output energy storage module reaches the first preset voltage, the first preset voltage being greater than the second preset voltage. In one embodiment, in a case that the power supply component is in a non-fault state, if the voltage of the output energy storage module drops below the second preset voltage due to its own loss, the output energy storage module is charged by cyclically executing the above cycling steps, ensuring sufficient power in the output energy storage module.

In some embodiments, as shown in FIGS. 4 to 6, the power-down holding circuit further includes multiple transducer switch modules 50, where the transducer switch modules 50 are connected in series in a one-to-one correspondence between the input circuits 41 and the corresponding output circuits 42. In other words, the first terminal of the transducer switch module is electrically connected to the output terminal of the input circuit, the transducer switch module is electrically connected to the input energy storage component via the output terminal of the input circuit, and the second terminal of the transducer switch module is electrically connected to both the input terminal of the output circuit and the first terminal of the output energy storage module. The method further includes that in the case of a fault in part of the input circuit, the first switch module is controlled to open; and the transducer switch module corresponding to the faulty input circuit is at least controlled to close, causing the corresponding output energy storage module of the closed transducer switch module to discharge. In this embodiment, the power-down holding circuit is controlled by independent transducer switch modules between the power supply components. In the case of an input circuit fault, only the transducer switch module corresponding to the faulty input circuit is closed to achieve energy supply for the faulty channel, effectively achieving functional isolation between the power supply components.

In another optional solution, the multiple output energy storage modules are respectively a first output energy storage module, a second output energy storage module, . . . , an i-th output energy storage module, . . . , and an n-th output energy storage module; and the output energy storage component further includes n fourth switch modules, where the second terminal of the intermediate energy storage module is electrically connected to the first terminal of the first output energy storage module via a first fourth switch module, a first terminal of an i-th fourth switch module is electrically connected to a first terminal of an (i−1)-th output energy storage module, a second terminal of an i-th fourth switch module is electrically connected to the first terminal of the i-th output energy storage module, and 1<i≤n; where that the transducer switch module corresponding to the failed input circuit is at least controlled to close includes that the transducer switch module corresponding to the failed input circuit is controlled to close, the corresponding output energy storage module of the closed transducer switch module being a target energy storage module; and at least one target switch module is controlled to close, the target switch module being a fourth switch module electrically connected to a first terminal of the target energy storage module, causing at least two of the output energy storage modules to discharge in parallel. In the case of partial input circuit failure, closing the transducer switch module corresponding to the faulty channel allows the output energy storage module corresponding to the faulty channel to discharge. When the power of the output energy storage module corresponding to the faulty channel is insufficient to support the power demand of the power system corresponding to the faulty channel, multiple output energy storage modules are connected in parallel by controlling at least part of the fourth switch modules to close. This ensures sufficient power to support the emergency business processing of the power system in the faulty channel, thereby achieving on-demand energy sharing, supply, and balance of the distributed energy storage modules.

For example, in a case that the target energy storage module is the third output energy storage module, the second output energy storage module and the third output energy storage module may be connected in parallel for discharge by controlling the third fourth switch module between the second output energy storage module and the third output energy storage module to close. Additionally, while the third fourth switch module is closed, at least one of the following may also be closed: the second fourth switch module between the first output energy storage module and the second output energy storage module, or the fourth fourth switch module between the third output energy storage module and the fourth output energy storage module. This achieves parallel discharge of three adjacent output energy storage modules or four adjacent output energy storage modules. By analogy, more fourth switch modules may further be closed to achieve parallel discharge of more output energy storage modules.

In some embodiments, after the cycling step, the method further includes that the first switch module is controlled to open. In other words, in a case that the voltage value stored in the output energy storage module reaches the first preset voltage, the first switch module is controlled to open. This realizes the intermittent control of the operation of the power-down holding circuit, which can reduce the static loss of the entire power supply system, and effectively improve the light load efficiency of the power supply system, and is also beneficial for electromagnetic compatibility design.

In one embodiment, when the first switch module is controlled to open, the functional module corresponding to the first switch module, which is the functional module controlling the switch state of the first switch module, is closed.

Through the description of the above implementations, those skilled in the art can clearly understand that the method according to the above embodiments can be implemented by means of software plus necessary general hardware platforms. Certainly, the method may be alternatively implemented by hardware, but in many cases, the former is a better implementation. Based on this understanding, the technical solution of this application can essentially or partially contribute to the related art and may be embodied in the form of a software product. The computer software product is stored in a non-volatile readable storage medium (such as ROM/RAM, magnetic disk, or optical disk), including several instructions to enable a terminal device (which may be a mobile phone, computer, server, or network device) to execute the method described in the various embodiments of this application.

In this embodiment, a control apparatus for the power-down holding circuit is also provided. This apparatus is configured to implement the above embodiments and optional implementations, which have been described and will not be repeated. As used herein, the term “module” may be a combination of software and/or hardware that performs a predetermined function. Although the apparatus described in the following embodiments is preferably implemented by software, it is also possible and contemplated to implement it by hardware, or a combination of software and hardware.

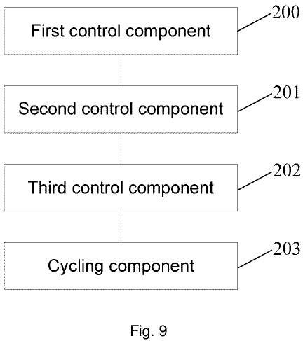

FIG. 9 is a block diagram of the control apparatus for the power-down holding circuit according to an embodiment of this application. As shown in FIG. 9, the apparatus includes:
a first control component 200, configured to execute a first control step: the power supply component is controlled to power on in a case that the power supply component operates normally, causing the output terminal of the input circuit to output a preset voltage and charge the input energy storage component;
a second control component 201, configured to execute a second control step: the first switch module is controlled to close in a case that the power supply component abnormally powers down, to charge the intermediate energy storage module;
a third control component 202, configured to execute a third control step: the first switch module is controlled to open in a case that the power supply component abnormally powers down and a charging duration for the intermediate energy storage module reaches a preset duration, causing the intermediate energy storage module to discharge, so as to charge at least part of the output energy storage module; and
a cycling component 203, configured to execute a cycling step: the second control step and the third control step are cyclically executed a predetermined number of times until a voltage of the at least part of the output energy storage modules reaches a first preset voltage.

In the foregoing embodiment, the first control component controls the power supply component to power on, such that the input circuit outputs a preset voltage through the output terminal to charge the input energy storage component, and then the second control component controls the first switch module to close, to charge the intermediate energy storage module. Next, the third control component controls the first switch module to open, stopping charging the intermediate energy storage module, thus allowing the intermediate energy storage module to discharge to supply energy to at least part of the output energy storage module. Finally, the cycling component cyclically closes and opens the first switch module, to repeat the process of charging the intermediate energy storage module and discharging the intermediate energy storage module to charge the output energy storage module, such that the stored voltage of the output energy storage module reaches the first preset voltage, achieving the power-up energy storage of the power-down holding circuit. The above process achieves the on-demand replenishment of the output energy storage module through the switch control of the first switch module. Thus, in a case of a fault in one or more of the input circuits, the output energy storage module after energy storage can output energy to maintain the function of the power supply component in a fault state. This allows sufficient time for the electrical system to handle emergency operations in the case of a power supply system failure, ensuring the safe operation of the electrical system.

In some embodiments, as shown in FIGS. 4 to 6, the input energy storage component includes multiple input energy storage modules 11, first terminals of the input energy storage modules 11 are electrically connected to the output terminals of the input circuits 41 in a one-to-one correspondence, and second terminals of the multiple input energy storage modules 11 are grounded. The input energy storage component further includes multiple second switch modules 12. The first terminal of the intermediate energy storage module 31 is configured to be electrically connected to the input terminals of the multiple input circuits 41 via the multiple second switch modules 12. The second switch modules 12 are in a one-to-one correspondence to the input terminals of the input circuits 41. In other words, the first terminal of the second switch module 12 is electrically connected to the input terminal of the input circuit 41 in a one-to-one correspondence, and the second terminal of the second switch module 12 is electrically connected to the first terminal of the intermediate energy storage module 31. A shared energy storage module 13 is also included, where a first terminal of the shared energy storage module 13 is electrically connected to the first terminal of the intermediate energy storage module 31. In other words, the first terminal of the shared energy storage module 13 is electrically connected to the intermediate energy storage module 31 and the second terminals of each second switch module 12, and the second terminal of the shared energy storage module 13 is electrically connected to the second terminal of the first switch module 32, that is, the second terminal of the shared energy storage module 13 is grounded. The first control component includes a first control module configured to control the power supply component to power on and control each second switch module to close, causing the output terminal of the input circuit to output a preset voltage, so as to charge each output energy storage module and the shared energy storage module. The power supply component is controlled to power on, such that the output terminal of the input circuit inputs the preset voltage, directly charging each input energy storage module, and the second switch module is controlled to close, to charge the shared energy storage module.

In order to ensure that the power-down holding circuit can provide sufficient energy supply during a power-down, according to some example embodiments of this application, the apparatus further includes an executing component, which is configured to execute the cycling step in a case that the voltage of the at least part of the output energy storage module is less than a second preset voltage, until the voltage of the at least part of the output energy storage module reaches the first preset voltage, the first preset voltage being greater than the second preset voltage. In one embodiment, in a case that the power supply component is in a non-fault state, if the voltage of the output energy storage module drops below the second preset voltage due to its own loss, the output energy storage module is charged by cyclically executing the above cycling steps, ensuring sufficient power in the output energy storage module.

In some embodiments, as shown in FIGS. 4 to 6, the power-down holding circuit further includes multiple transducer switch modules 50, where the transducer switch modules 50 are connected in series in a one-to-one correspondence between the input circuits 41 and the corresponding output circuits 42. In other words, the first terminal of the transducer switch module is electrically connected to the output terminal of the input circuit, the transducer switch module is electrically connected to the input energy storage component via the output terminal of the input circuit, and the second terminal of the transducer switch module is electrically connected to both the input terminal of the output circuit and the first terminal of the output energy storage module. The apparatus further includes: a fourth control component, configured to, in the case of a fault in part of the input circuit, control the first switch module to open; and a fifth control component, configured to at least control the transducer switch module corresponding to the faulty input circuit to close, causing the corresponding output energy storage module of the closed transducer switch module to discharge. In this embodiment, the power-down holding circuit is controlled by independent transducer switch modules between the power supply components. In the case of an input circuit fault, only the transducer switch module corresponding to the faulty input circuit is closed to achieve energy supply for the faulty channel, effectively achieving functional isolation between the power supply components.

In another optional solution, the multiple output energy storage modules are respectively a first output energy storage module, a second output energy storage module, . . . , an i-th output energy storage module, . . . , and an n-th output energy storage module; and the output energy storage component further includes n fourth switch modules, where the second terminal of the intermediate energy storage module is electrically connected to the first terminal of the first output energy storage module via a first fourth switch module, a first terminal of an i-th fourth switch module is electrically connected to a first terminal of an (i−1)-th output energy storage module, a second terminal of an i-th fourth switch module is electrically connected to the first terminal of the i-th output energy storage module, and 1<i≤n. The fifth control component includes: a second control module, configured to control the transducer switch module corresponding to the failed input circuit close, the corresponding output energy storage module of the closed transducer switch module being a target energy storage module; and a third control module, configured to control at least one target switch module to close, the target switch module being a fourth switch module electrically connected to a first terminal of the target energy storage module, causing at least two of the output energy storage modules to discharge in parallel. In the case of partial input circuit failure, closing the transducer switch module corresponding to the faulty channel allows the output energy storage module corresponding to the faulty channel to discharge. When the power of the output energy storage module corresponding to the faulty channel is insufficient to support the power demand of the power system corresponding to the faulty channel, multiple output energy storage modules are connected in parallel by controlling at least part of the fourth switch modules to close. This ensures sufficient power to support the emergency business processing of the power system in the faulty channel, thereby achieving on-demand energy sharing, supply, and balance of the distributed energy storage modules.

For example, in a case that the target energy storage module is the third output energy storage module, the second output energy storage module and the third output energy storage module may be connected in parallel for discharge by controlling the third fourth switch module between the second output energy storage module and the third output energy storage module to close. Additionally, while the third fourth switch module is closed, at least one of the following may also be closed: the second fourth switch module between the first output energy storage module and the second output energy storage module, or the fourth fourth switch module between the third output energy storage module and the fourth output energy storage module. This achieves parallel discharge of three adjacent output energy storage modules or four adjacent output energy storage modules. By analogy, more fourth switch modules may further be closed to achieve parallel discharge of more output energy storage modules.

In some embodiments, the apparatus further includes a sixth control component, configured to control the first switch module to open after the cycling step. In other words, in a case that the voltage value stored in the output energy storage module reaches the first preset voltage, the first switch module is controlled to open. This realizes the intermittent control of the operation of the power-down holding circuit, which can reduce the static loss of the entire power supply system, and effectively improve the light load efficiency of the power supply system, and is also beneficial for electromagnetic compatibility design.

In one embodiment, when the first switch module is controlled to open, the functional module corresponding to the first switch module, which is the functional module controlling the switch state of the first switch module, is closed.

It should be noted that the above modules may be implemented by software or hardware. For the latter, it can be implemented in the following ways, but not limited to these: the above modules are all located in the same processor; or the above modules are located in different processors in any combination.

An embodiment of this application provides a non-volatile readable storage medium, and the non-volatile readable storage medium stores a computer program, where the computer program is configured to execute the steps of any method embodiments described above when running.

In an example embodiment, the non-volatile readable storage medium may include but is not limited to: USB flash drive, Read-Only Memory (Read-Only Memory, ROM), Random Access Memory (Random Access Memory, RAM), mobile hard drive, magnetic disk, or optical disk, and other media that can store computer programs.

An embodiment of this application provides an electronic device, including a memory and a processor, where the memory stores a computer program, and the processor is configured to run the computer program to execute the steps of any method embodiments described above.

In an example embodiment, the electronic device may further include transmission equipment and input/output device, where the transmission equipment is connected to the processor, and the input/output device is connected to the processor.

According to another embodiment of this application, a server power supply system is also provided, including: multiple power supply components, where the power supply component includes an input circuit and an output circuit, and an output terminal of the input circuit is electrically connected to an input terminal of the output circuit; the power-down holding circuit described above; and a controller, including a memory, a processor, and a computer program stored on the memory and executable by the processor, where the processor executes the steps of the method described above.

In the server power supply system, the power-down holding circuit of this application is bypassed between the input circuits and output circuits of multiple power supply components, functioning as an independent part to perform power-down holding operations. As compared with the related art where the power-down holding circuit is connected in series between the input circuit and output circuit of each power supply component, the solution of this application of bypassing the power-down holding circuit between the input circuits and output circuits can reduce the efficiency impact of the power-down holding circuit on the main power loop of the power supply component. Additionally, because the power-down holding circuit is not connected in series between the input and output circuits of the power supply component, the power requirements of the power-down holding circuit are lower. Furthermore, in this application, one power-down holding circuit corresponds to multiple power supply components, so the power-down holding circuit occupies less space, which is conducive to the integration and miniaturization design of servers.

In one embodiment, the input circuit typically includes an isolation circuit, a rectification circuit, and an electromagnetic compatibility circuit. The output circuit includes a converter and an ORing circuit, where the converter includes an LLC topology structure.

Optional examples in this embodiment can refer to the examples described in the above embodiments and exemplary implementations, and will not be repeated herein.

Obviously, those skilled in the art should understand that the modules or steps of this application may be implemented using a general-purpose computing device. They can be concentrated in a single computing device or distributed across a network of multiple computing devices. They can be implemented using executable program code on computing devices, and thus can be stored in storage devices and executed by the computing devices. In some cases, the steps shown or described may be executed in a different order, or they may be made into individual integrated circuit modules, or multiple modules or steps thereof may be made into a single integrated circuit module. Thus, this application is not limited to any specific hardware and software combination.

The above are merely optional embodiments of this application and are not intended to limit this application. For those skilled in the art, this application can have various modifications and changes. Any modifications, equivalent replacements, improvements, or the like made within the principles of this application should be included in the scope of protection of this application.

1. A power-down holding circuit for power supply component, wherein multiple power supply components are provided, the power supply component comprises an input circuit and an output circuit, an output terminal of the input circuit is electrically connected to an input terminal of the output circuit, and the power-down holding circuit comprises:
an input energy storage component, wherein the input energy storage component is configured to be electrically connected to all the output terminals of the input circuits of the multiple power supply components;
an output energy storage component, comprising multiple output energy storage modules, wherein first terminals of the output energy storage modules are configured to be electrically connected to the input terminals of the output circuits in a one-to-one correspondence, and second terminals of the output energy storage modules are grounded; and
an intermediate energy storage component, comprising an intermediate energy storage module and a first switch module, wherein a first terminal of the intermediate energy storage module is configured to be electrically connected to all the output terminals of the multiple input circuits, a second terminal of the intermediate energy storage module is electrically connected to a first terminal of the first switch module and the first terminal of each output energy storage module, and a second terminal of the first switch module is grounded.

2. The power-down holding circuit according to claim 1, wherein the output energy storage component further comprises at least one of the following:
multiple current limiting components, wherein the current limiting components are connected in series, in a one-to-one correspondence, to connection circuits between the output energy storage modules and the output circuits; and
multiple voltage clamping components, wherein the multiple voltage clamping components are connected in parallel, each corresponding to two terminals of the output energy storage module.

3. The power-down holding circuit according to claim 2, wherein the current limiting component comprises a resistor, the voltage clamping component comprises a first diode, an anode of the first diode is electrically connected to the second terminal of the output energy storage module, and a cathode of the first diode is electrically connected to the first terminal of the output energy storage module.

4. The power-down holding circuit according to claim 1, wherein the output energy storage component further comprises:
multiple third switch modules, wherein the second terminal of the intermediate energy storage module is electrically connected to the first terminal of the output energy storage module via the third switch module, and the third switch modules are in a one-to-one correspondence to the output energy storage modules.

5. The power-down holding circuit according to claim 4, wherein the third switch module comprises a second diode, an anode of the second diode is electrically connected to the second terminal of the intermediate energy storage module, and a cathode of the second diode is electrically connected to the first terminal of the output energy storage module.

6. The power-down holding circuit according to claim 1, wherein the multiple output energy storage modules are respectively a first output energy storage module, a second output energy storage module, . . . , an i-th output energy storage module, . . . , and an n-th output energy storage module, and the output energy storage component further comprises:
n fourth switch modules, wherein the second terminal of the intermediate energy storage module is electrically connected to the first terminal of the first output energy storage module via a first fourth switch module, a first terminal of an i-th fourth switch module is electrically connected to a first terminal of an (i−1)-th output energy storage module, a second terminal of the i-th fourth switch module is electrically connected to the first terminal of the i-th output energy storage module, and 1<i≤n.

7. The power-down holding circuit according to claim 6, wherein the fourth switch module comprises at least one of the following: a third diode and a bidirectionally conductive switching tube.

8. The power-down holding circuit according to claim 1, wherein the power-down holding circuit further comprises:
multiple transducer switch modules, wherein the transducer switch modules are connected in series in a one-to-one correspondence between the input circuits and the corresponding output circuits.

9. The power-down holding circuit according to claim 1, wherein the input energy storage component comprises:
multiple input energy storage modules, wherein first terminals of the input energy storage modules are electrically connected to the output terminals of the input circuits in a one-to-one correspondence, and second terminals of the multiple input energy storage modules are grounded.

10. The power-down holding circuit according to claim 9, wherein the input energy storage module, the output energy storage module, and the intermediate energy storage module each comprise at least one of the following: a capacitor and an inductor.

11. The power-down holding circuit according to claim 9, wherein the input energy storage component further comprises:
multiple second switch modules, wherein the first terminal of the intermediate energy storage module is configured to be electrically connected to all the input terminals of the multiple input circuits via the multiple second switch modules, and the second switch modules are in a one-to-one correspondence to the input terminals of the input circuits; and
a shared energy storage module, wherein a first terminal of the shared energy storage module is electrically connected to the first terminal of the intermediate energy storage module, and a second terminal of the shared energy storage module is electrically connected to the second terminal of the first switch module.

12. The power-down holding circuit according to claim 11, wherein the first switch module and the second switch module each comprise one of the following: a transistor, a MOS transistor, and a thyristor, and the shared energy storage module comprises at least one of the following: a capacitor and an inductor.

13. A control method implemented by the power-down holding circuit according to claim 12, comprising:
a first control step: controlling the power supply component to power on in a case that the power supply component operates normally, causing the output terminal of the input circuit to output a preset voltage and charge the input energy storage component;
a second control step: controlling the first switch module to close in a case that the power supply component abnormally powers down, to charge the intermediate energy storage module;
a third control step: controlling the first switch module to open in a case that the power supply component abnormally powers down and a charging duration for the intermediate energy storage module reaches a preset duration, causing the intermediate energy storage module to discharge, so as to charge at least part of the output energy storage module; and
a cycling step: cyclically executing the second control step and the third control step a predetermined number of times until a voltage of the at least part of the output energy storage modules reaches a first preset voltage.

14. The method according to claim 13, wherein the input energy storage component comprises multiple input energy storage modules, first terminals of the input energy storage modules are electrically connected to the output terminals of the input circuits in a one-to-one correspondence, and second terminals of the multiple input energy storage modules are grounded; the input energy storage component further comprises: multiple second switch modules, wherein the first terminal of the intermediate energy storage module is configured to be electrically connected to all the input terminals of the multiple input circuits via the multiple second switch modules, and the second switch modules are in a one-to-one correspondence to the input terminals of the input circuits; and a shared energy storage module, wherein a first terminal of the shared energy storage module is electrically connected to the first terminal of the intermediate energy storage module, and a second terminal of the shared energy storage module is electrically connected to the second terminal of the first switch module; and the first control step comprises:
controlling the power supply component to power on and controlling each second switch module to close, causing the output terminal of the input circuit to output the preset voltage, so as to charge each output energy storage module and the shared energy storage module.

15. The method according to claim 13, wherein the method further comprises:
executing the cycling step in a case that the voltage of the at least part of the output energy storage module is less than a second preset voltage, until the voltage of the at least part of the output energy storage module reaches the first preset voltage, the first preset voltage being greater than the second preset voltage.

16. The method according to claim 13, wherein the power-down holding circuit further comprises multiple transducer switch modules, the transducer switch modules are connected in series in a one-to-one correspondence between the input circuits and the corresponding output circuits, and the method further comprises:
controlling the first switch module to open in a case that part of the input circuit fails; and
at least controlling a transducer switch module corresponding to the failed input circuit to close, causing a corresponding output energy storage module of the closed transducer switch module to discharge.

17. The method according to claim 16, wherein the multiple output energy storage modules are respectively a first output energy storage module, a second output energy storage module, . . . , an i-th output energy storage module, . . . , and an n-th output energy storage module; and the output energy storage component further comprises n fourth switch modules, wherein the second terminal of the intermediate energy storage module is electrically connected to the first terminal of the first output energy storage module via a first fourth switch module, a first terminal of an i-th fourth switch module is electrically connected to a first terminal of an (i−1)-th output energy storage module, a second terminal of an i-th fourth switch module is electrically connected to the first terminal of the i-th output energy storage module, and 1<i≤n; wherein the at least controlling a transducer switch module corresponding to the failed input circuit to close comprises:
controlling the transducer switch module corresponding to the failed input circuit to close, the corresponding output energy storage module of the closed transducer switch module being a target energy storage module; and
controlling at least one target switch module to close, the target switch module being a fourth switch module electrically connected to a first terminal of the target energy storage module, causing at least two of the output energy storage modules to discharge in parallel.

18. The method according to claim 13, wherein after the cycling step, the method further comprises:
controlling the first switch module to open.

19. (canceled)

20. A server power supply system, comprising:
multiple power supply components, wherein the power supply component comprises an input circuit and an output circuit, and an output terminal of the input circuit is electrically connected to an input terminal of the output circuit;
the power-down holding circuit according to a power-down holding circuit for power supply component; wherein the power-down holding circuit comprises:
an input energy storage component, wherein the input energy storage component is configured to be electrically connected to all the output terminals of the input circuits of the multiple power supply components;
an output energy storage component, comprising multiple output energy storage modules, wherein first terminals of the output energy storage modules are configured to be electrically connected to the input terminals of the output circuits in a one-to-one correspondence, and second terminals of the output energy storage modules are grounded; and
an intermediate energy storage component, comprising an intermediate energy storage module and a first switch module, wherein a first terminal of the intermediate energy storage module is configured to be electrically connected to all the output terminals of the multiple input circuits, a second terminal of the intermediate energy storage module is electrically connected to a first terminal of the first switch module and the first terminal of each output energy storage module, and a second terminal of the first switch module is grounded; and
a controller, comprising a memory, a processor, and a computer program stored on the memory and executable by the processor, wherein the processor executes the steps of the method according to following actions when executing the computer program:
a first control step: controlling the power supply component to power on in a case that the power supply component operates normally, causing the output terminal of the input circuit to output a preset voltage and charge the input energy storage component;
a second control step: controlling the first switch module to close in a case that the power supply component abnormally powers down, to charge the intermediate energy storage module;
a third control step: controlling the first switch module to open in a case that the power supply component abnormally powers down and a charging duration for the intermediate energy storage module reaches a preset duration, causing the intermediate energy storage module to discharge, so as to charge at least part of the output energy storage module; and
a cycling step: cyclically executing the second control step and the third control step a predetermined number of times until a voltage of the at least part of the output energy storage modules reaches a first preset voltage.

21. The power-down holding circuit according to claim 2, wherein the current limiting component comprises a power resistor or composed of multiple power resistors connected in series and parallel, the voltage clamping component comprises a zener diode or a transient voltage suppression diode.
